(19) United States
(12) Patent Application Publication
(10) Pub. No.: US 2010/0003070 A1
(43) Pub. Date: Jan. 7, 2010

(54) RING MECHANISM HAVING FOLD-DOWN RINGS

(75) Inventor: Hung Yu CHENG, Hong Kong (CN)

Correspondence Address: Patent Docket Department;Armstrong Teasdale LLP, One Metropolitan Square, Suite 2600, St. Louis, MO, 63102-2740, US

(73) Assignee: WORLD WIDE STATIONERY, MFG. CO., LTD., Hong Kong (CN)

(21) Appl. No.: 12/165,997

(22) Filed: Jul. 1, 2008

(51) Int. Cl. B42F 3/04; B42F 13/00

(52) U.S. Cl. 402/38; 402/36; 402/41; 402/73

(57) ABSTRACT

A ring mechanism includes a housing, a plurality of rings for holding loose-leaf pages, and a plurality of locking elements. Each ring is supported by the housing and includes a first ring member and a second ring member. The first ring member is moveable relative to the second ring member between a closed position and an opened position. Each ring is moveable relative to the housing between an upright configuration in which the ring stands generally upright from the housing and a fold-down configuration in which the ring generally lies against the housing. Each locking element is associated with one of the rings and moveable relative to the housing between a locked position wherein each of the rings is locked in the upright configuration and an unlocked position wherein each of the rings is moveable between the upright configuration and the fold-down configuration.

### FIELD

The field of this invention relates generally to ring mechanisms for retaining loose-leaf pages, and more particularly to ring mechanisms having rings that are pivotable between an upright configuration and a fold-down configuration.

### BACKGROUND

Ring mechanisms are used to retain loose-leaf pages, such as hole-punched pages, in a file or binder. Typically, ring mechanisms include a housing, a pair of adjacent hinge plates supported by the housing, and a plurality of rings (e.g., three) for retaining the pages. Each of the rings often includes a pair of ring members mounted on the respective hinge plates. In one known arrangement, the hinge plates are supported by the housing and are loosely joined together about a pivot axis for pivotal movement relative the housing. As a result, the rings can be selectively moved, via movement of the hinge plates, between an opened position for adding/removing pages and a closed position for retaining pages on the rings while allowing the pages to be moved along the rings. More specifically, the housing is narrower than the joined hinge plates when the hinge plates are in a coplanar position (180 degrees) so as the hinge plates pivot through this position (i.e., move upward or downward), they deform the resilient housing and cause a spring force in the housing that urges the hinge plates to pivot away from the coplanar position thereby moving the rings to either their opened position or their closed position.

One drawback of conventional ring mechanisms relates to shipping, handling, and storing of the mechanisms and the associated binder. A single ring mechanism can take up a relatively large amount of space when packed for shipping or storing because the rings project outward from the housing of the mechanism. As a result, gaps are formed between the rings of each mechanism, leaving large amounts of room unused during shipping and storing of multiple mechanisms. In response to this drawback, manufacturers of ring mechanisms typically pack the binders having the mechanisms mounted thereto in alternating directions. However, the size and shape of the rings still leave large amounts of space unused. Packing conventional ring mechanisms attached to binders is inefficient, which results in high shipping and handling costs.

### BRIEF DESCRIPTION OF THE INVENTION

In one aspect, a ring mechanism for retaining loose-leaf pages generally comprises a housing having a longitudinal axis, a plurality of rings for holding loose-leaf pages, and a plurality of locking elements. Each ring is supported by the housing and includes a first ring member and a second ring member. The first ring member is moveable relative to the second ring member between a closed position and an opened position. In the closed position, the two ring members form a substantially continuous, closed loop for allowing loose-leaf pages retained by the rings to be moved along the rings from one ring member to the other. In the opened position, the two ring members form a discontinuous, open loop for adding or removing loose-leaf pages from the rings. Each ring is moveable relative to the housing between an upright configuration in which the ring stands generally upright from the housing and a fold-down configuration in which the ring generally lies against the housing. Each locking element is associated with one of the rings and is moveable relative to the housing between a locked position wherein each of the rings is locked in the upright configuration and an unlocked position wherein each of the rings is moveable between the upright configuration and the fold-down configuration.

In another aspect, a ring mechanism for retaining loose-leaf pages generally comprises a housing having an upper member and a plurality of rings for holding loose-leaf pages. Each ring is mounted on the upper member of the housing and includes a first ring member and a second ring member. The first ring member is moveable relative to the second ring member between a closed position and an opened position. In the closed position, the two ring members form a substantially continuous, closed loop for allowing loose-leaf pages retained by the rings to be moved along the rings from one ring member to the other. In the opened position, the two ring members form a discontinuous, open loop for adding or removing loose-leaf pages from the rings. Each ring is moveable relative to the housing between an upright configuration in which the ring stands generally upright from the housing and a fold-down configuration in which the ring generally lies against the housing.

In yet another aspect, a ring mechanism for retaining loose-leaf pages generally comprises a housing having a longitudinal axis, a plurality of rings for holding loose-leaf pages, and a plurality of locking elements. Each ring is supported by the housing and includes a first ring member and a second ring member. The first ring member is moveable relative to the second ring member between a closed position and an opened position. In the closed position, the two ring members form a substantially continuous, closed loop for allowing loose-leaf pages retained by the rings to be moved along the rings from one ring member to the other. In the opened position, the two ring members form a discontinuous, open loop for adding or removing loose-leaf pages from the rings. Each ring is moveable relative to the housing between a first configuration in which the ring stands generally upright from the housing and a second configuration. The ring mechanism has a first height in the first configuration of the rings and a second height in the second configuration of the rings. The second height is less than the first height. Each locking element is associated with one of the rings and moveable relative to the housing between a locked position wherein each of the rings is locked in the first configuration and an unlocked position wherein each of the rings is moveable between the first configuration and the second configuration.

### BRIEF DESCRIPTION OF THE DRAWINGS

FIG. 1 is a perspective of a binder incorporating one embodiment of a ring mechanism having a plurality of rings and a locking assembly, the rings being illustrated closed and in a fold-down configuration and the locking assembly being illustrated in an unlocked position;

FIG. 2 is a perspective similar to FIG. 1 but with the rings of the ring mechanism illustrated in an upright configuration and the locking assembly in a locked position;

FIG. 3 is a perspective of the ring mechanism separated from the binder, the rings being in their fold-down configuration and the locking assembly in its unlocked position;

FIG. 4 is a bottom perspective of the ring mechanism illustrated in FIG. 3;

FIG. 5 is a perspective similar to FIG. 3 but illustrating the rings as being pivoted partially from their fold-down configuration to their upright configuration, and the locking assembly being in its unlocked position;

FIG. 6 is a perspective similar to FIG. 5 but with the rings in their upright configuration and the locking assembly in its unlocked position;

FIG. 7 is an exploded perspective of the ring mechanism;

FIG. 8 is a perspective similar to FIG. 6 but with the locking assembly in its locked position;

FIG. 9 is a bottom perspective of the ring mechanism illustrated in FIG. 8;

FIG. 10 is a top plan of the ring mechanism with the rings in their upright configuration and the locking assembly in its locked position;

FIG. 11 is a cross section taken in the plane of line 11-11 of FIG. 10 plus the rings being illustrated in their fold-down configuration in phantom;

FIG. 12 is a perspective similar to FIG. 8 but with the rings opened;

FIG. 13 is a perspective of another embodiment of a ring mechanism having a plurality of rings and a locking assembly, the rings being illustrated closed and in an upright configuration and the locking assembly being illustrated in a locked position;

FIG. 14 is an exploded perspective of the ring mechanism of FIG. 13; and

FIG. 15 is a perspective of the ring mechanism of FIG. 13 with the rings in their fold-down configuration and the locking assembly in an unlocked position.

Corresponding reference characters indicate corresponding parts throughout the various views of the drawings.

### DETAILED DESCRIPTION OF THE DRAWINGS

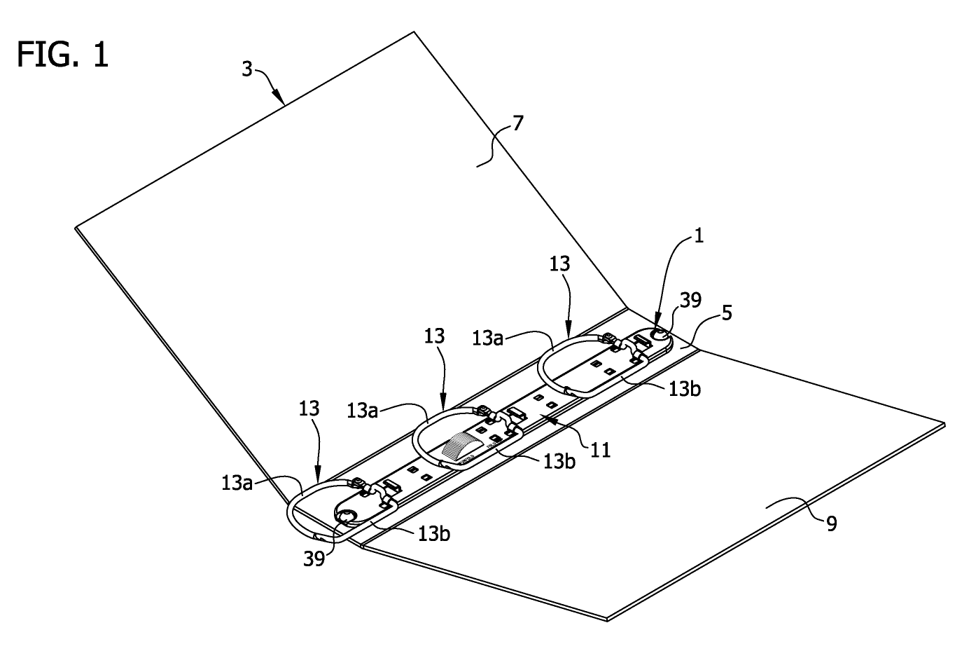

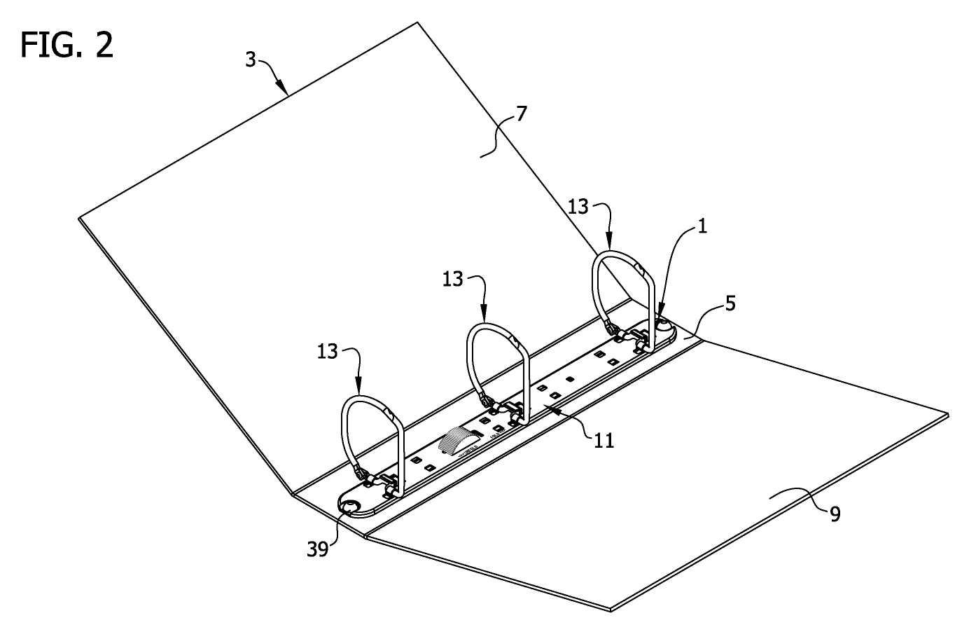

Referring now to the drawings, FIGS. 1-12 illustrate a first embodiment of a ring mechanism, which is designated generally by reference numeral 1. The ring mechanism 1 is used to retain loose-leaf pages, such as hole-punched papers (not shown), in a binder, which is designated generally by reference numeral 3 (FIGS. 1 and 2). As illustrated in FIGS. 1 and 2, the binder 3 has a spine 5, a front cover 7, and a back cover 9. The front and back covers 7, 9 of the binder are hinged to the spine 5 for allowing selected movement of the front and back covers to cover or expose the loose-leaf pages retained by the ring mechanism 1. It is understood, however, that the ring mechanism 1 may be mounted on substrates other than a binder (e.g., a folder) without departing from the scope of this invention.

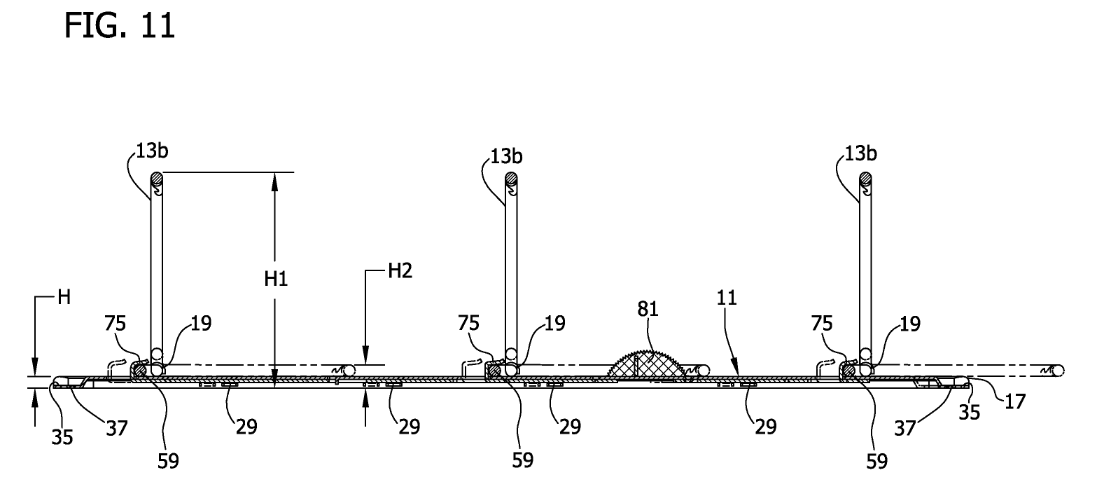

The illustrated ring mechanism 1 comprises a low-profile housing (designated generally by reference numeral 11) and three rings (each designated generally by reference numeral 13) mounted on the housing. As used herein, the phrase low-profile housing means a housing having a height H less than about 5 millimeters (mm). In the illustrated embodiment, for example, the height H of the housing 11 is about 2.5 mm (see FIG. 11) but it is understood that the housing can be of a different height and in some embodiments it may be other than a low profile housing. In one suitable embodiment, the height H of the housing 11 is less than about 2.5 mm and, more suitability, between about 0.4 mm and about 1.2 mm. As described in more detail below, the low-profile housing 11 contributes to the overall compactness of the present ring mechanism 1, which can be efficiently packaged, e.g., for shipping and/or storage, either individually or as mounted on the binder 3.

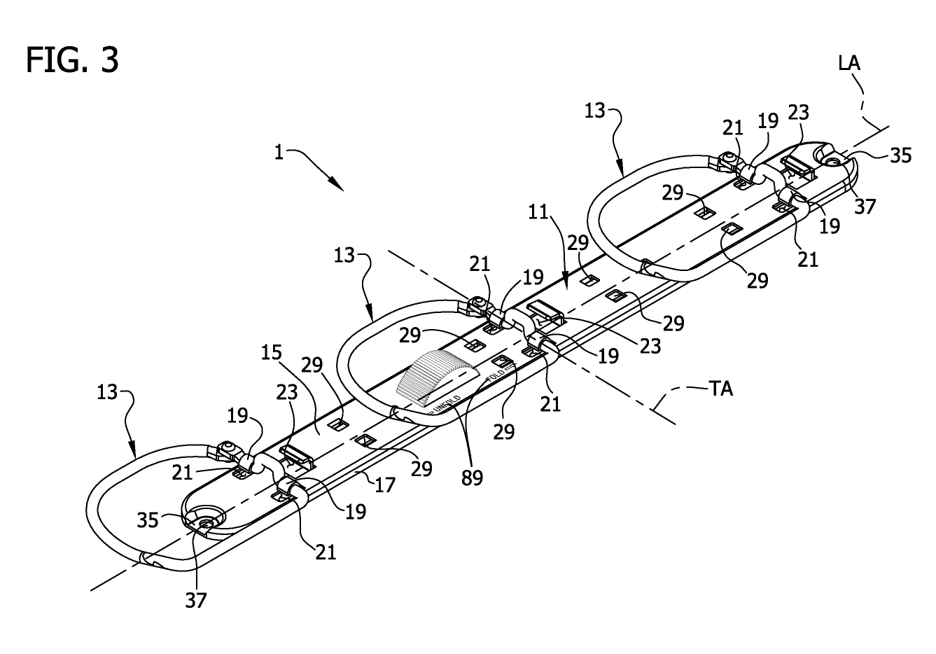

With reference to FIG. 3, the illustrated housing 11 of the ring mechanism 1 is elongate having a longitudinal axis LA and a transverse axis TA. The housing 11 has a generally planar upper member 15 and a peripheral skirt 17 extending downward from the upper member. The upper member 15 of the housing 11 includes a plurality of retaining members 19 (e.g., hooks in the illustrated embodiment) sized and shaped for capturing and securing the rings 13 to the housing. In one suitable embodiment, the retaining members 19 are cut and bent from the upper member 15 of the housing 11 resulting in cutouts 21 being associated with each retaining member. It is understood, however, that the retaining members 19 can be formed in a different manner including being formed separate from the housing 11 and attached thereto.

In the illustrated embodiment, each of the three rings 13 is captured by and secured to the upper surface of the housing 11 by a respective pair of the retaining members 19. The locations of the retaining members 19 on the housing 11 are determined by the desired longitudinal location of and spacing between the rings 13. In one suitable embodiment, for example, one of the pairs of retaining members 19 is disposed approximately along the transverse axis TA of the hosing and each of the other two pairs of retaining members are disposed on longitudinally opposite sides of the transverse axis and generally adjacent or approaching the longitudinal ends of the housing. It is contemplated that the rings 13 can be mounted to the housing 11 in other ways and that the ring mechanism 1 may have more than or fewer than three rings without departing from the scope of this invention.

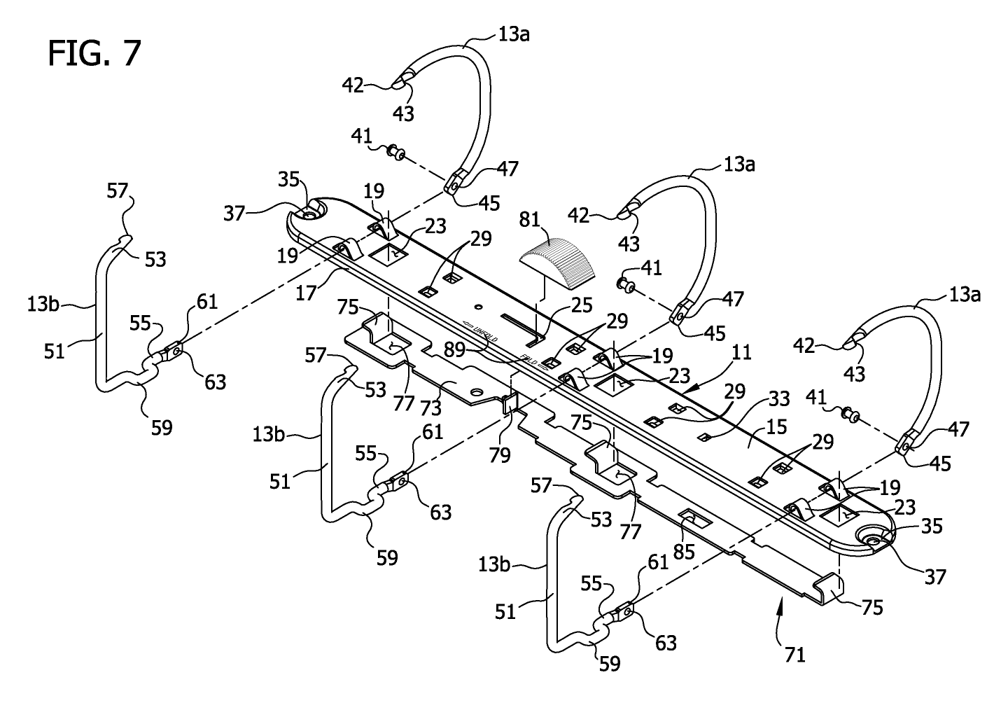

As best seen in FIG. 7, the housing 11 has three generally rectangular, and more particularly square, cutouts 23 formed in the upper member 15 and spaced along its longitudinal axis LA. One of the cutouts 23 is disposed generally adjacent to each of the pairs of retaining members 19. The housing 11 also includes a generally L-shaped slot 25 formed in its upper member 15. The purpose of the cutouts 23 and L-shaped slot 25 is described below.

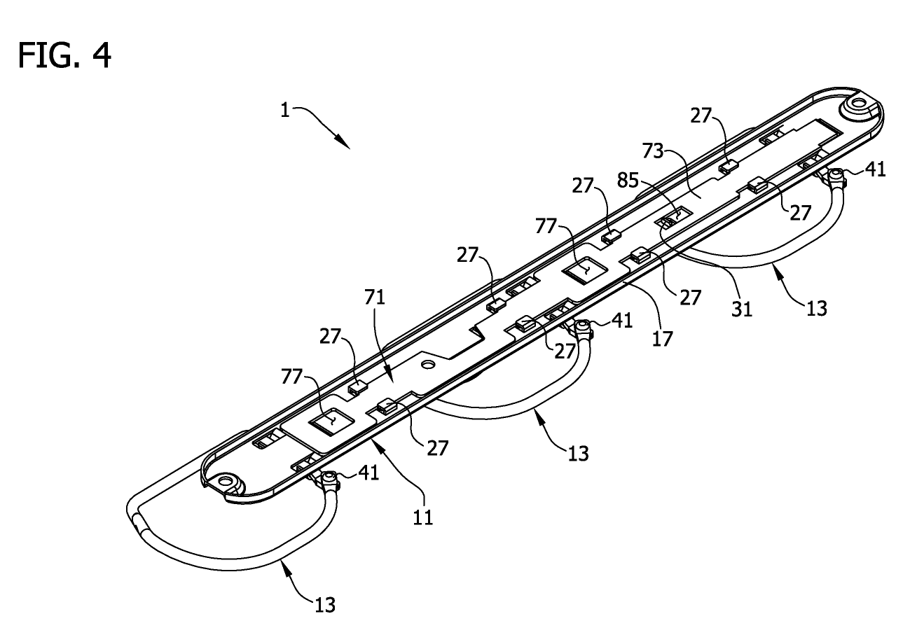

With reference back to FIG. 4, the housing 11 further comprises four pair of tabs 27 (eight tabs in total) depending from the upper member 15 of the housing. Each of the tabs 27 is suitably constructed by cutting and bending portions of the upper member 15 of the housing 11 downward and transversly inward. Thus, each of the tabs 27 has an associated cutout 29. The housing 11 also includes a stop 31 that is cut and bent downward from the upper member 15 (FIG. 4) and, as a result, also has an associated cutout 33 (FIG. 7). It is understood that in other embodiments the tabs 27 and stop 31 may be formed separate from the housing 11 and attached thereto.

Each of the longitudinal ends of the housing 11 has a recessed portion 35 (FIG. 3) with an opening 37 formed therein for receiving a fastener (e.g., a rivet 39) to mount the housing to the spine 5 of the binder 3 (FIG. 1). It is contemplated, however, that the housing 11 can be attached to the binder 3 in other suitable manners and remain within the scope of this invention.

Each of the three rings 13 of the mechanism 1 are of substantially the same shape and construction. As illustrated in FIG. 7, for example, each of the rings 13 comprises a first ring member 13a and a second ring member 13b. The first ring members 13a are generally C-shaped and have a first end 42 with a latch formation 43 and a second, flattened end 45 having an eyelet 47 formed therein. Each of the second ring members 13b is generally L-shaped having a generally straight portion 51, an upper portion 53, and a lower portion 55. The upper portion 53 includes a free end having a catch formation 57 for releasable engagement with the latch formation 43 of the first ring member 13a. The lower portion 55 includes a stand 59 in the form of a bent portion and a flattened end 61 having an eyelet 63 formed therein. The first and second ring members 13a, 13b are pivotally secured together via a suitable pivot pin 41 extending through the eyelets 47, 63 located in the flattened ends 45, 61 of the respective first and second ring members.

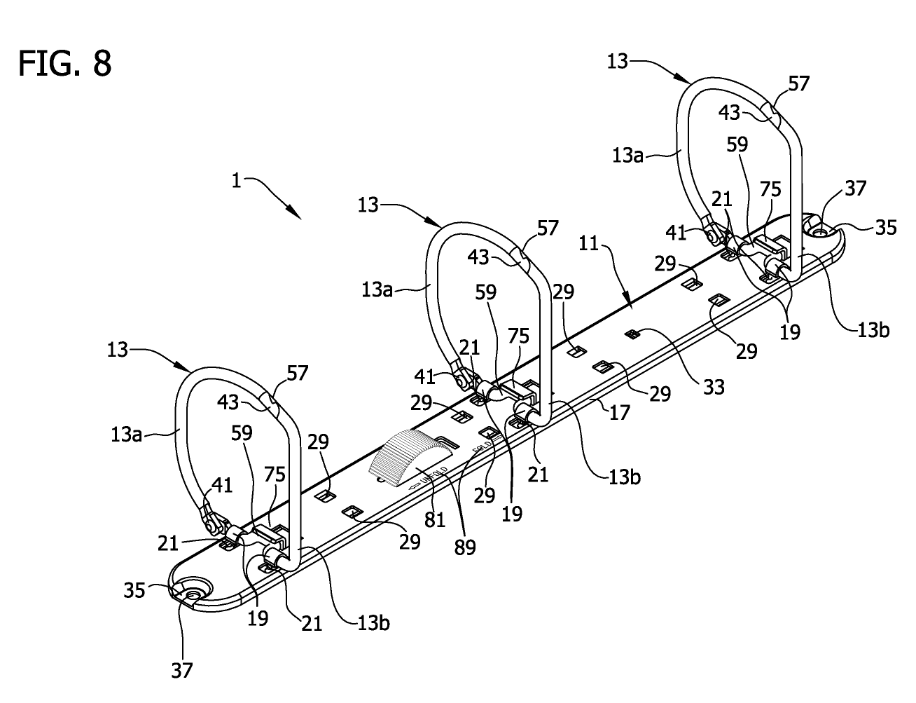

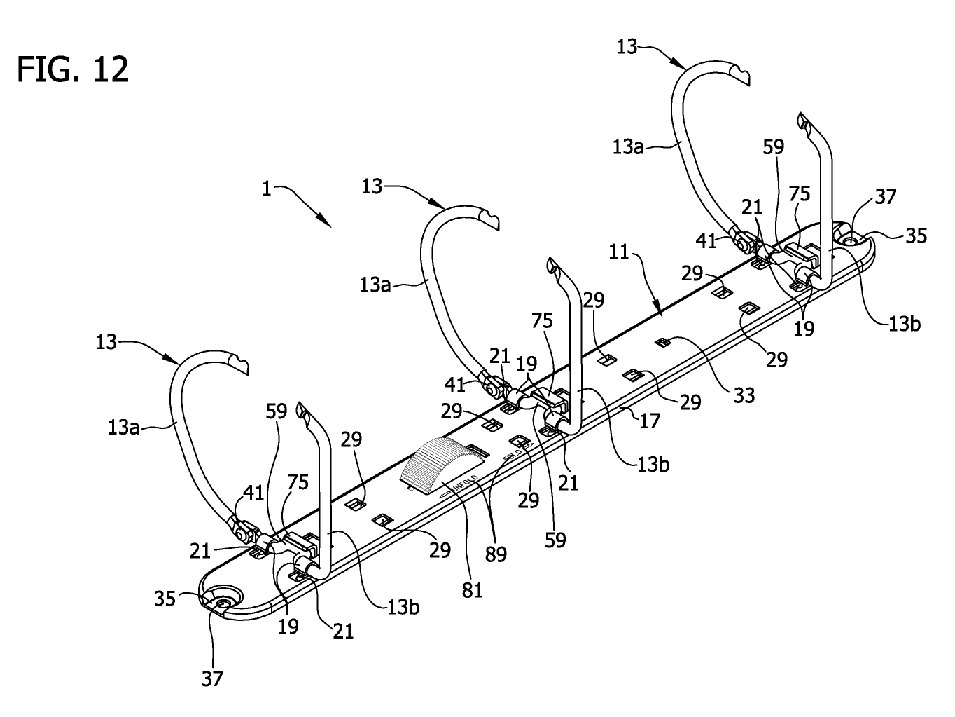

Each of the first ring members 13a is thus capable of pivoting relative to the respective second ring member 13b between a closed position (FIG. 8) and an opened position (FIG. 12) of the ring. In the closed position, the two ring members 13a, 13b form a substantially continuous, closed loop for allowing loose-leaf pages retained by the rings 13 to be moved along the rings from one ring member to the other, and in the opened position the two ring members form a discontinuous, open loop for adding or removing loose-leaf pages to or from the rings. More specifically, each of the first ring members 13a is pivotally attached to the second ring member 13b via the pivot pin 41 and can thus be pivoted independent of the other rings 13. That is, each ring 13 can be moved between their opened and closed positions separately. It is contemplated, however, that the rings 13 can be operatively connected for conjoint movement of all of the rings between their opened and closed positions.

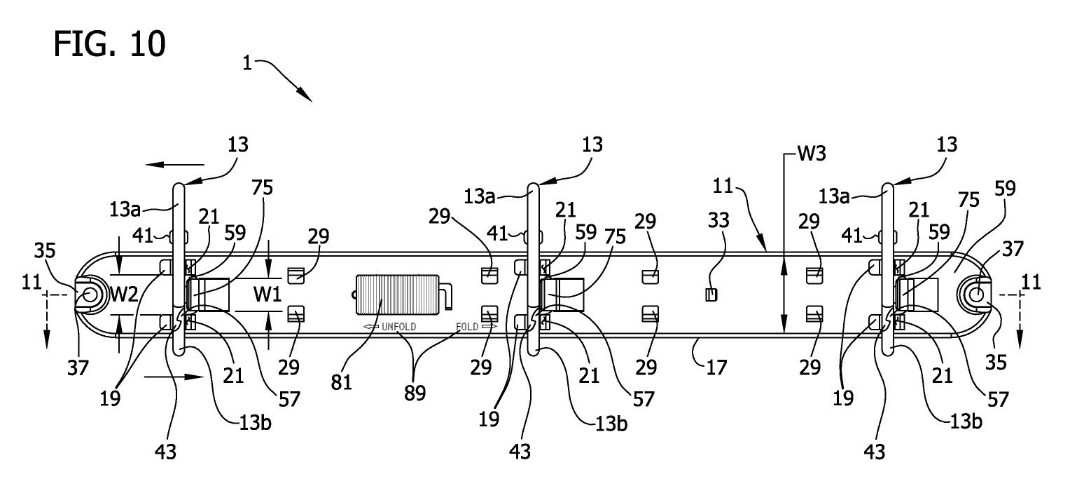

The latch and catch formations 43, 57 of the first and second ring members 13a, 13b are shaped to releaseably interlock when the rings are closed (FIG. 8). The ring members 13a, 13b can be disengaged by manually moving one or both of the ring members away from the other in a direction generally parallel to the longitudinal axis LA of the housing 11 (as indicated by the arrows in FIG. 10). With the latch and catch formations 43, 57 disengaged, the first ring member 13a can be pivoted about the pivot pin 41 relative to the second ring member 13b and thereby move the respective ring 13 to its opened position. The illustrated ring members 13a, 13b are formed of a conventional, cylindrical rod of suitable material, such as steel. But it is understood that ring members can have a different overall shape or cross section, or that the ring members may be made of different material without departing from the scope of the present invention.

The rings 13 are pivotally held by the retaining members 19 of the housing 11 for movement between an upright configuration (broadly, a “first configuration”) in which the rings can retain loose-leaf pages (FIG. 8) and a fold-down configuration (broadly, a “second configuration) in which the mechanism 1 can be efficiently packed for shipping or storing (FIG. 3). It is understood that the rings 13 can be in either their closed position or their opened position and still move between their upright configuration and the fold-down configuration. FIGS. 1, 3, and 4 illustrate the ring mechanism 1 in their fold-down configuration wherein each of the rings 13 is lying generally flat against the housing 11. It can be seen that in the fold-down configuration the ring mechanism 1 takes up substantially less space, (i.e., thickness, or height). More specifically and as illustrated in FIG. 11, the ring mechanism has a first height H1 when the rings are in their upright configuration and a second height H2 when the rings are in their fold-down configuration that is less than the first height. Thus with each of the rings in its fold-down configuration, the ring mechanism 1 can be packaged efficiently for shipping and/or storage even when attached to the binder 3. As a result, a relatively large number of ring mechanisms 1 or binders 3 each having a ring mechanism mounted therein can be shipped and/or stored in the same package.

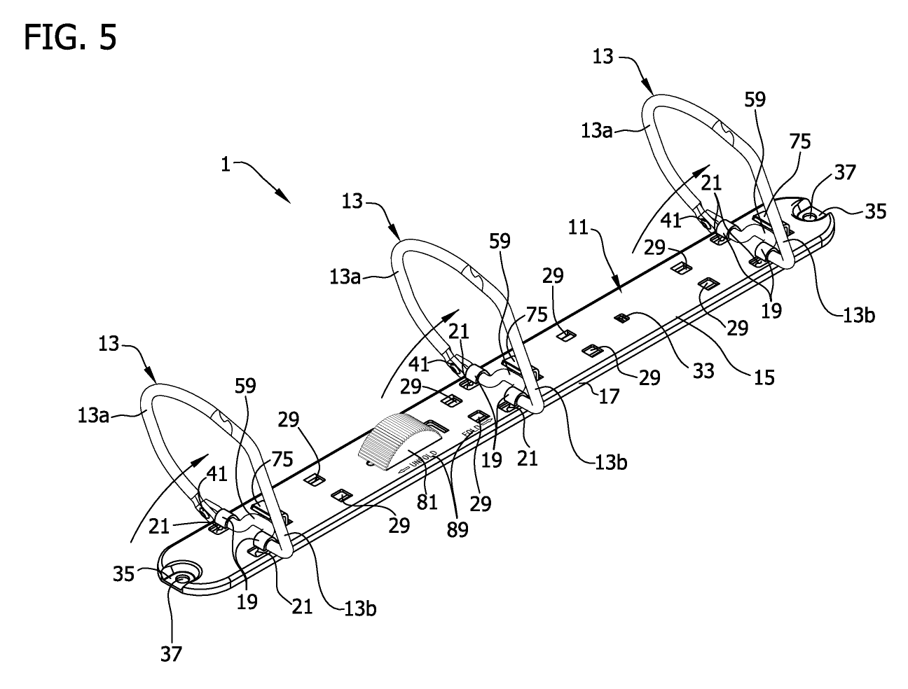

With reference to FIG. 5, each of the rings 13 can be pivoted independently of the other rings from their fold-down configuration to their upright configuration and vice versa. To move the rings between positions, a user manually grasps one of the rings 13 and pivots it relative to the housing 11 until the stand 59 of the ring engages the upper member 15 of the housing to positively indicate that the rings are in their upright configuration. The user then manually pivots each of the other two rings 13 in the same manner. In the illustrated embodiment, each of the rings 13 is pivoted in the same direction, which is toward the left as viewed in FIGS. 1 and 3 upon movement to their fold-down configuration and toward the right upon movement to their upright configuration. It should be understood, though, that the rings 13 can be pivoted to the right to their fold-down configuration and to the left to their upright configuration or in different directions relative to each other without departing from the scope of this invention.

The ring mechanism 1 further comprises a locking assembly, indicated generally at 71, for locking the rings 13 in their upright configuration. As illustrated in FIG. 7, the locking assembly 71 includes a slide member 73 having three locking elements 75 (one for each ring) adapted for capturing and securing the rings 13 in their upright configuration. In the illustrated embodiment, the slide member is a generally flat bar and the locking elements 75 are formed from portions of the flat bar. In particular, two of the locking elements 75 are formed by cutting and bending portions of the flat bar and therefore have cutouts 77 associated therewith. The other locking element 75 is formed by bending one of the longitudinal ends of the sliding member 73 and therefore does not have an associated cutout. Each of the locking elements 75 is generally L-shaped or hook-shaped to capture the stand 59 of the respective ring 13. The slide member 73 also includes a generally rectangular aperture 85.

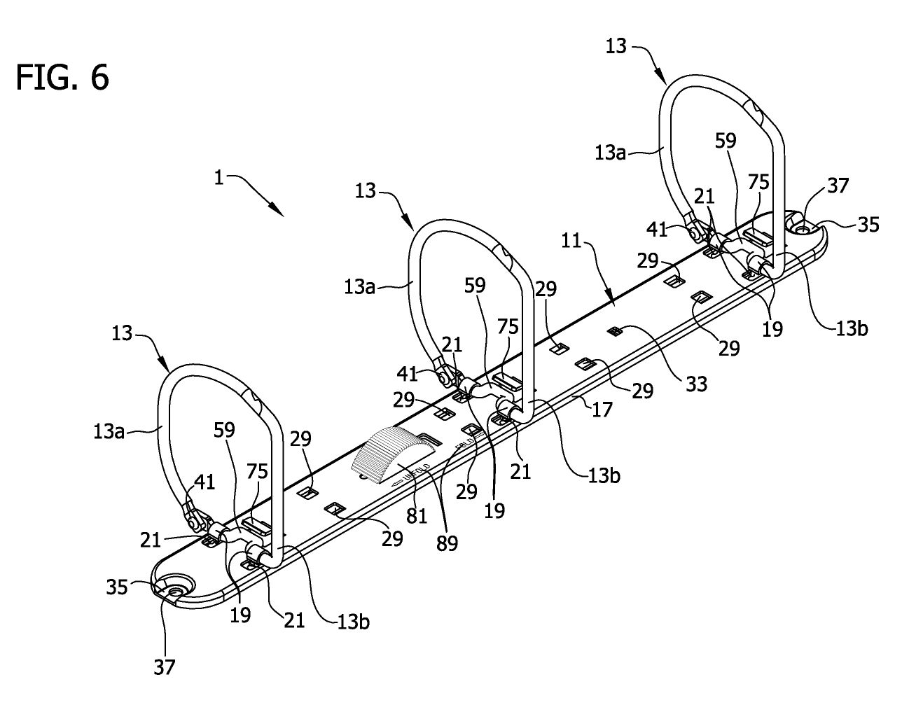

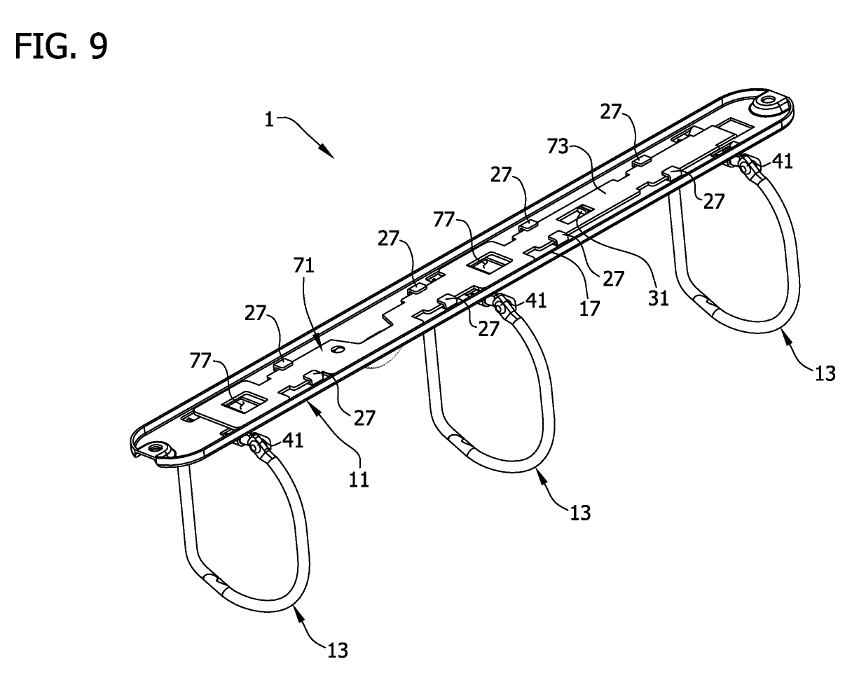

As illustrated in FIGS. 4 and 9, the slide member 73 is secured to the underside of the housing 11 by the tabs 27 and is slidable relative to the housing 11 as described in further detail below. With the slide member 73 secured to the housing 11, each of the locking elements 75 extends through one of the cutouts 23 formed in the upper member 15 of the housing 11 (see, e.g., FIG. 6). With reference again to FIGS. 4 and 9, the stop 31 of the housing 11 extends into the rectangular aperture 85 in the slide member 73 to limit the sliding movement of the slide member relative to the housing.

The locking assembly 71 further comprises a tab 79 (FIG. 7) extending up from the slide member 73 through the L-shaped slot 25 in the housing 11. An actuator 81 (e.g., a slide button in the illustrated embodiment) is mounted on the tab 79 for sliding movement along the upper member 15 of the housing 11. The actuator 81 is operatively connected to the slide member 73 via the tab 79 so that sliding movement of the actuator causes corresponding movement of the slide member 73 and thereby the locking elements 75 formed therewith. Accordingly, a user can manually operate the actuator 81 to move the locking assembly 71, and more specifically the locking elements 75, between a locked position wherein each of the rings 13 is locked in the upright configuration by the associated locking element (FIG. 8) and an unlocked position wherein each of the rings is pivotable between their collapsed and upright configurations (FIG. 6). In the illustrated embodiment, indicia 89 are provided on the housing 11 adjacent the actuator 81 to indicate the positions of the actuator corresponding to the locked and unlocked positions of the locking elements 75.

In the unlocked position as illustrated in FIGS. 3 and 6, the locking elements 75 are spaced from the stands 59 of each of the rings 13 thereby allowing the rings to pivot relative to the housing 11 between their collapsed and upright positions. In their locked position, however, the locking elements 75 overlie and capture the stands 59 of the rings 13. In this position, the locking elements 75 and the upper member 15 of the housing cooperatively inhibit the rings 13 from pivoting. That is, the stand 59 of each of the rings 13 and thereby the ring itself is prevented from pivoting relative to the housing and therefore is unable to be moved to its fold-down configuration.

In one suitable embodiment, each of the locking elements 75 has a width W1 that generally corresponds to a width W2 of the stands 59 of the rings 13 (FIG. 10) thereby providing a large contact area between the locking elements and the stands, which provides a stable and secure lock for the rings. As illustrated in FIG. 10, the stands 59 are only slightly wider than the locking elements. Suitably, the width W1 of the locking elements 75 is between about 10 percent and about 50 percent of a width W3 of the upper member 15 of the housing, and more suitably between about 15 percent and about 40 percent. In the illustrated embodiment, for example, the width W1 of the locking elements 75 is about 36.5 percent of the width W3 of the upper member 15 of the housing 11, which is approximately 26 mm. It is contemplated that the width W3 of the upper member 15 of the housing 11 can be greater than or less than 26 mm, however, without departing from the scope of this invention.

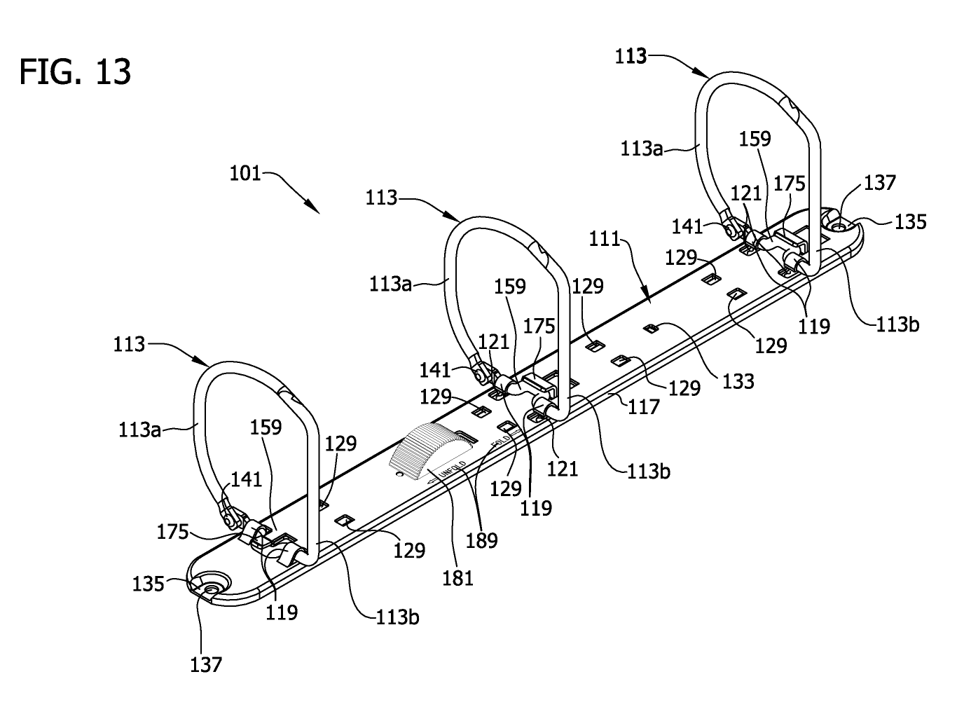

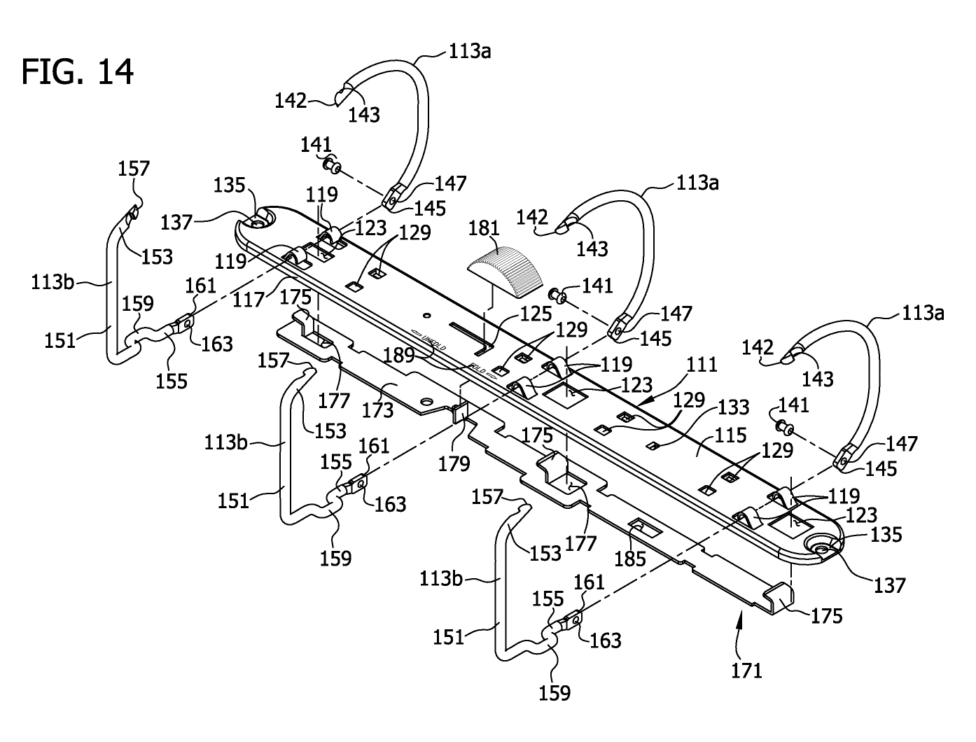

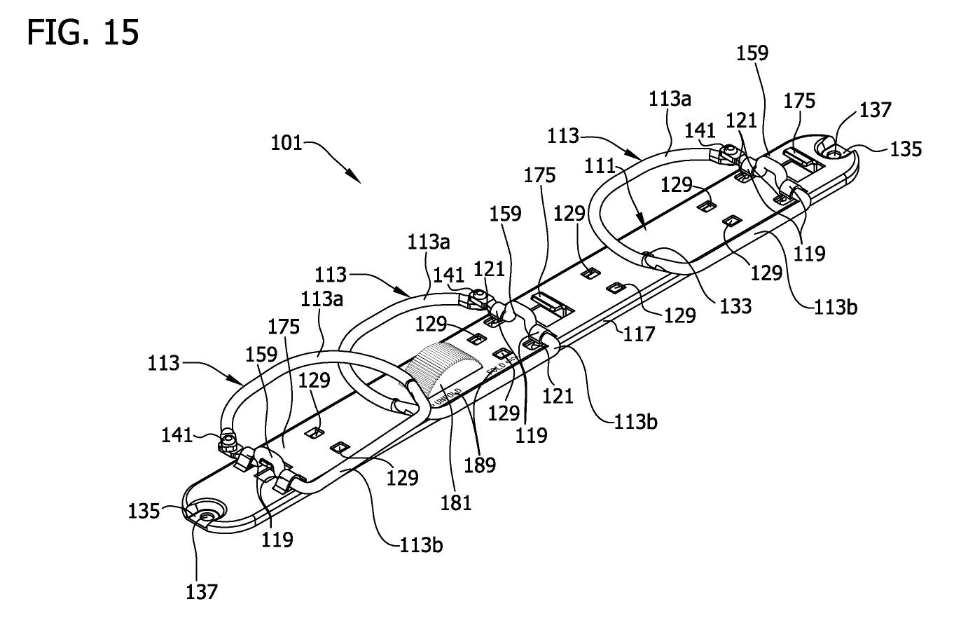

FIGS. 13-15 illustrate a ring mechanism, generally indicated at 101, according to a second embodiment. Corresponding parts of the mechanism 101 of the second embodiment will be designated by the same reference numerals as used for the first embodiment, plus “100”. The mechanism 101 is substantially the same as mechanism 1 of the first embodiment of FIGS. 1-12 except that one of the three rings 113 is pivotable relative to a housing 111 in a direction opposite the other two. As a result, one of the rings 113 overlies another ring in their fold-down configuration as illustrated in FIG. 15. In addition, one of the three locking elements 175 is narrower than the other two. As illustrated in FIG. 14, for example, the leftmost locking element 175 as viewed is narrower than the other two. In the illustrated embodiment, the leftmost locking element 175 has a width that is about 17 percent of the width of an upper member 115 of the housing 111, which is approximately 26 mm. In all other aspects, including the operation of the ring mechanism 101 to open and close the ring members 113a, 113b; to pivot the rings 113 between their upright and fold-down configurations; and to move the locking elements 175 between their locked and unlocked positions, ring mechanism 101 is the same as ring mechanism 1 of FIGS. 1-12.

When introducing elements of the invention according to the several embodiments, the articles “a”, “an”, “the” and “said” are intended to mean that there are one or more of the elements. The terms “comprising”, “including” and “having” are intended to be inclusive and mean that there may be additional elements other than the listed elements. Moreover, the use of “up” and “down” and variations of these terms is made for convenience, but does not require any particular orientation of the components. Furthermore, “bottom” and “top” as used herein are not meant to limit the scope of the invention. They are relative terms used to indicate relationship of parts within the ring mechanism. Top is generally used to refer to a location of a structural component generally facing the housing. While bottom generally refers to a location generally facing away from the housing.

As various changes could be made in the above without departing from the scope of the invention, it is intended that all matter contained in the above description and shown in the accompanying drawings shall be interpreted as illustrative and not in a limiting sense.

What is claimed is:

1. A ring mechanism for retaining loose-leaf pages, the mechanism comprising:
a housing having a longitudinal axis;
a plurality of rings for holding loose-leaf pages, each ring being supported by the housing and including a first ring member and a second ring member, the first ring member being moveable relative to the second ring member between a closed position and an opened position, in the closed position the two ring members forming a substantially continuous, closed loop for allowing loose-leaf pages retained by the rings to be moved along the rings from one ring member to the other, and in the opened position the two ring members forming a discontinuous, open loop for adding or removing loose-leaf pages from the rings, each ring being moveable relative to the housing between an upright configuration in which the ring stands generally upright from the housing and a fold-down configuration in which the ring generally lies against the housing; and
a plurality of locking elements, each locking element being associated with one of the rings and moveable relative to the housing between a locked position wherein each of the rings is locked in the upright configuration and an unlocked position wherein each of the rings is moveable between the upright configuration and the fold-down configuration.

2. The ring mechanism set forth in claim 1 wherein each of the locking elements is operatively connected such that the locking elements are moveable between the locked and unlocked positions simultaneously.

3. The ring mechanism set forth in claim 2 wherein the locking elements are operatively connected to each other via a slide member, the slide member being moveable in a direction generally parallel to the longitudinal axis of the housing.

4. The ring mechanism set forth in claim 3 further comprising an actuator for manually moving the slide member and thereby each of the locking elements.

5. The ring mechanism set forth in claim 4 wherein the actuator is disposed on the upper member of the housing.

6. The ring mechanism set forth in claim 4 wherein the locking elements, slide member, and at least a portion of the actuator are formed as a single-piece.

7. The ring mechanism set forth in claim 1 wherein each of the locking elements is generally hook-shaped to capture a portion of the respective ring in the upright configuration of the ring.

8. The ring mechanism set forth in claim 1 wherein each of the rings include at least one stand for inhibiting the rings from pivoting past their upright configuration.

9. The ring mechanism set forth in claim 8 wherein each of the generally hook-shaped locking elements is adapted to overlie the at least one stand in the locked position of the locking elements.

10. The ring mechanism set forth in claim 9 wherein each of the locking elements has a width, each stand having a width that generally corresponds to the width of the respective locking elements.

11. The ring mechanism set forth in claim 10 wherein the housing has a width, the width of the locking elements being between about 10 percent and about 50 percent of the width of the housing.

12. The ring mechanism set forth in claim 11 wherein the width of the locking elements is between about 15 percent and about 40 percent of the width of the housing.

13. The ring mechanism set forth in claim 12 wherein the width of the locking elements is about 36.5 percent of the width of the housing.

14. The ring mechanism set forth in claim 1 in combination with a binder, the ring mechanism being mounted on the binder.

15. A ring mechanism for retaining loose-leaf pages, the mechanism comprising:
a housing having an upper member; and
a plurality of rings for holding loose-leaf pages, each ring being mounted on the upper member of the housing and including a first ring member and a second ring member, the first ring member being moveable relative to the second ring member between a closed position and an opened position, in the closed position the two ring members forming a substantially continuous, closed loop for allowing loose-leaf pages retained by the rings to be moved along the rings from one ring member to the other, and in the opened position the two ring members forming a discontinuous, open loop for adding or removing loose-leaf pages from the rings, each ring being moveable relative to the housing between an upright configuration in which the ring stands generally upright from the housing and a fold-down configuration in which the ring generally lies against the housing.

16. The ring mechanism as set forth in claim 15 each of the rings include a stand for inhibiting the rings from moving past their upright configuration.

17. The ring mechanism as set forth in claim 16 wherein the stand comprises a bent portion of the associated ring.

18. The ring mechanism as set forth in claim 17 wherein the bent portion is adapted to engage the upper member of the housing to thereby inhibit the respective ring from pivoting past its upright configuration.

19. The ring mechanism as set forth in claim 15 wherein each of the rings can be moved between its opened and closed position independently of the other rings.

20. The ring mechanism as set forth in claim 15 wherein each of the rings can be moved between its upright and fold-down configuration independently of the other rings.

21. The ring mechanism as set forth in claim 15 further comprising a locking element associated with each of the rings and being moveable relative to the housing between a locked position wherein each of the rings is locked in the upright configuration and an unlocked position wherein each of the rings is moveable between the fold-down configuration and the upright configuration.

22. The ring mechanism as set forth in claim 15 wherein the housing has a height that is less than or equal to 5 millimeters.

23. The ring mechanism set forth in claim 15 in combination with a binder, the ring mechanism being mounted on the binder.

24. A ring mechanism for retaining loose-leaf pages, the mechanism comprising:
a housing having a longitudinal axis;
a plurality of rings for holding loose-leaf pages, each ring being supported by the housing and including a first ring member and a second ring member, the first ring member being moveable relative to the second ring member between a closed position and an opened position, in the closed position the two ring members forming a substantially continuous, closed loop for allowing loose-leaf pages retained by the rings to be moved along the rings from one ring member to the other, and in the opened position the two ring members forming a discontinuous, open loop for adding or removing loose-leaf pages from the rings, each ring being moveable relative to the housing between a first configuration in which the ring stands generally upright from the housing and a second configuration, the ring mechanism having a first height in the first configuration of the rings and a second height in the second configuration of the rings, the second height being less than the first height; and
a plurality of locking elements, each locking element being associated with one of the rings and moveable relative to the housing between a locked position wherein each of the rings is locked in the first configuration and an unlocked position wherein each of the rings is moveable between the first configuration and the second configuration.
